(19) United States
(12) Patent Application Publication
(10) Pub. No.: US 2010/0062772 A1
(43) Pub. Date: Mar. 11, 2010

(54) METHOD, WIRELESS COMMUNICATION SYSTEM, AND GROUP MOBILITY CONTROLLER FOR PROCESSING GROUP MOBILITY

(75) Inventors: Yan Peng, Shenzhen (CN); Zheng Shang, Shenzhen (CN); Bin Xia, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/554,094

(22) Filed: Sep. 4, 2009

Related U.S. Application Data
(63) Continuation of application No. PCT/CN2008/070406, filed on Mar. 4, 2008.

(30) Foreign Application Priority Data
Mar. 5, 2007 (CN) 200710079412.9

(51) Int. Cl. H04W 36/00; H04W 68/00

(52) U.S. Cl. 455/436; 455/458

(57) ABSTRACT

A method, a wireless communication system, and a group mobility controller (GMC) for processing group mobility are provided by the exemplary embodiments of the present invention. In the method, a fixed GMC paging group identifier (PG-ID) is assigned to the GMC when the GMC starts up a group mobility function; and a target network obtains group information of the GMC, and updates a PG-ID list of the target network with the group information of the GMC during a message interaction process when the GMC hands over from a serving network to the target network, and then utilizes the updated PG-ID list during a subsequent interaction process with a group node. The system includes a GMC, a serving network, and a target network. The signaling storm raised when numbers of terminals in an idle mode perform location update at the same time during the group mobility can be avoided according to the above technical solutions, thereby realizing the economy of air interface resources and signaling overheads.

### CROSS-REFERENCE TO RELATED APPLICATIONS

This application is a continuation of International Application No. PCT/CN2008/070406, filed on Mar. 4, 2008, which claims priority to Chinese Patent Application No. 200710079412.9, filed on Mar. 5, 2007, both of which are hereby incorporated by reference in their entireties.

### FIELD OF THE INVENTION

The present invention relates to wireless communication technologies, more particularly, to technologies for processing group mobility.

### BACKGROUND OF THE INVENTION

In a wireless communication system, a mobile station (MS) has two basic states, that is, an active mode and an idle mode.

In the active mode, the MS is assigned with air interface resources, and performs data exchange with a network. When the MS moves from one cell to another, for example, air interface resources need to be reassigned to the MS in the new cell, and the original session or service flow of the MS is migrated into the new cell, so that the MS enters the new cell without interrupting the session as much as possible, which is referred to as a cell handover process.

The idle mode is an optional function defined in Institute of Electrical and Electronics Engineers (IEEE) 802.16e standard, which aims at saving the precious air interface resources and reducing the power consumption of the MS. In the idle mode, the MS may move within a large area, and the area may be formed by coverage areas of a plurality of base stations (BSs). Such BSs are referred to as a paging group (PG). In idle mode, the MS does not perform data exchange with the network side, so that the network side merely saves location information of the MS and activates the MS timely whenever necessary, without assigning air interface resources to the MS. Furthermore, when the MS roams within an area of the same PG, the MS does not need to register to a BS of the cell where it roams, so as to save the air interface resources and reduce the power consumption of the MS. The MS in the idle mode receives a downlink broadcast message or a paging message from the network in every certain period, and checks the PG identifier (PG-ID) carried in the message. If the PG-ID varies, the MS performs information interaction with the network, and reports the latest location of the MS to the network; alternatively, after a certain period or after a specific event occurs, the MS needs to perform interaction with the network and reports the latest location of the MS to the network, which is referred to as a location update process.

FIG. 1 is a schematic flow chart of an idle mode defined in IEEE 802.16e. Referring to FIG. 1, altogether four processes have been described from top to bottom, that is, a process that an MS enters an idle mode, a process that the MS performs a location update periodically in the idle mode, a process that the MS performs a location update upon receiving a paging message from a BS, and a process that the MS performs a network re-entry after receiving a paging message from the BS, which are respectively introduced below.

1. In the process that the MS enters the idle mode, the MS sends a deregister request (DREG_REQ) to a BS, the BS returns a deregister command (DREG_CMD) carrying a PG-ID to the MS, and the BS and the MS respectively start an idle mode system timer and an idle mode timer.

2. In the process that the MS performs a location update periodically in the idle mode, T1, shown in FIG. 1, is taken as a time interval for indicating a timeout of the location update. The MS takes T1 as a time period, and sends a ranging request (RNG_REQ) to the BS before the timeout of the timer, and the BS returns a ranging response (RNG_RSP) to the MS.

3. In the process that the MS performs a location update upon receiving a paging message from the BS, when the BS sends a mobility paging advertisement (MOB_PAG_ADV) to the MS to indicate that no downlink data has to be transferred, the MS performs the location update according to the MOB_PAG_ADV message.

4. In the process that the MS performs network re-entry upon receiving a paging message from the BS, when the BS has downlink data to be transferred, the BS sends a paging message to the MS to indicate that certain downlink data has to be transferred, for example, a MOB_PAG_ADV message indicating that downlink data has to be transferred, the MS performs network re-entry according to the message, that is, performs a ranging (RNG) process.

A plurality of MS nodes with the same mobility behavior may be defined as group nodes, and the mobility of the group nodes is referred to as group mobility, for example, mobility of a travel group, mobility of passengers on a vehicle, and mobility of other various small groups. Such nodes represent similar mobility paths and mobility occasions, and nearly all of them move from a coverage area of one network entity into a coverage area of another network entity. A group mobility controller (GMC) may be deployed in the group to provide services for the group nodes. For example, a mobility relay station (MRS) is defined in IEEE 802.16j. If an MRS is deployed in a train, the MRS serves as a GMC for providing services for MSs on the train.

When the MRS and a lot of MSs in the idle mode served by the MRS move from one PG area to another, that is, from a serving network to a target network, the MSs in the idle mode may all detect that the PG varies. In this case, almost all the MSs may initiate a location update process simultaneously, which causes severe conflicts during the synchronization of the air interface access, increases the signaling overhead, and results in the signaling storm. Thus, in IEEE 802.16j, the group mobility problem for the MSs in the idle mode has been studied, and a solution is proposed as follows.

The main idea of the solution lies in assigning an independent PG-ID to each MRS and the PG-ID remains unchanged during the mobility of the MRS. When the MRS and the MSs served by the MRS enter a new BS, that is, enter the target network, the MRS reports its own PG-ID during the RNG process, and then the target network updates a PG-ID list by using the PG-ID reported by the MRS, and uses a new PG-ID list containing the PG-ID reported by the MRS when delivering a message. FIG. 2 is a schematic flow chart of message interaction in a group mobility solution in the prior art, which includes the following steps.

In Step 1, a BS periodically broadcasts a downlink channel descriptor (DCD) message carrying a PG-ID of a PG that the BS belongs to.

In Step 2, once an MRS finds that the PG-ID information carried in the DCD message varies, on one hand, the MRS performs an RNG process with the BS (the specific interaction process can be obtained with reference to Step 3 and Step 4) to accomplish a PG update (PG_UPDATE); and on the other hand, the MRS may add its own PG-ID into a PG-ID list carried in the DCD message and sends the DCD message to the MS, or directly blocks the DCD message, so as to shield the MSs from detecting the variation of the PG information.

In Step 3, the MRS carries its own PG-ID in an RNG-REQ message and sends the RNG-REQ message to a new BS.

In Step 4, the new BS notifies the other BSs within the same PG area as the new BS to add the PG-ID into PG-ID lists of the other BSs, and returns an RNG-RSP message to the MRS.

In Step 5, the new BS then uses the new PG-ID list to deliver a DCD message, and the MRS stops amending or blocking the DCD message, and processes messages according to a normal flow.

In this case, when a PG area where the MS actually moves is changed, the MS does not sense that the original PG-ID disappears, but senses that another PG-ID(s) in the PG-ID list varies, so that the MS does not initiate a location update. However, the above solution has the following problems.

1. When the MRS enters the new BS from the original BS and performs the RNG process, the MRS has disconnected from the original BS. Accordingly, during a time period from the MRS disconnecting the original link to the MRS accomplishing a PG-ID update at the new BS, the paging for the MSs in the idle mode, which are served by the MRS, is delivered by the original BS. Therefore, the paging information can not be received by the MRS and the paged MSs. As a result, during such a time period, the network may fail to page the MSs in the idle mode which are served by the MRS.

2. If an integrity protection is performed on the message from the BS to the MS, the MRS needs to block the DCD message before finishing the PG-ID updating process. Since the updating process involves the interaction between the BS and other network elements in the backbone network, the time required cannot be neglected, so that the MS may sense an abnormity of the network in the period of the time, thereby initiating active location update and network re-entry activities, which increases the signaling overhand and results in the waste of air interface resources.

3. The above solution requires adding the PG-ID of the MRS into PF-ID lists of all the other BSs within the same PG area as the new BS, which prolongs a time delay during the PG-ID updating process; and in addition, during the process of paging the MS in the idle mode served by the MRS, the paging area is sent to all the other BSs, which increases the network overhead and the occupied air interface resources.

As can be seen from the above analysis, the group mobility solution in the prior art has problems of wasting the air interface resources, failing to ensure that the MS can be paged at any time, and failing to eliminate the signaling storm raised when numbers of MSs in the idle mode perform location update at the same time during the group mobility.

### SUMMARY OF THE INVENTION

In order to effectively avoid the signaling storm raised when numbers of mobile stations (MSs) in the idle mode perform location update at the same time during the group mobility, and realize the economy of air interface resources and signaling overheads, the present invention provides a method and a wireless communication system for processing group mobility. The technical solutions of the embodiments of the present invention are described in the following.

A method for processing group mobility is provided, which includes assigning a fixed group mobility controller (GMC) PG identifier (PG-ID) to a GMC when the GMC starts up a group mobility function, and the method may further includes the following step:

A target network obtains group information of the GMC and updates a PG-ID list of the target network using the group information of the GMC during a message interaction between a serving network and a target network while the GMC handing over from the serving network to the target network.

A wireless communication system is provided, which includes a GMC, a serving network, and a target network.

The GMC includes a group mobility function module. The group mobility function module is adapted to start up a group mobility function and obtain a fixed GMC PG-ID.

The target network includes a group information obtaining module and a first storage module. The group information obtaining module is adapted to obtain group information of the GMC, and notify the first storage module to update a PG-ID list stored in the first storage module with the group information of the GMC during a process of message interaction when the GMC hands over from a serving network to the target network.

A GMC is provided, which includes a group mobility function module.

The group mobility function module is adapted to start up a group mobility function and obtain a fixed GMC PG-ID, which is used for updating a PG-ID list of a target network during a message interaction between a serving network and the target network while the GMC handing over from the serving network to the target network.

As can be seen from the above technical solutions, in the method and system for processing group mobility according to the embodiments of the present invention, when the GMC starts up a group mobility function, a fixed GMC PG-ID is assigned to the GMC; and a target network obtains group information of the GMC, and updates a PG-ID list of the target network with the group information of the GMC during the process of message interaction when the GMC hands over from a serving network to the target network. Then, the target network can utilizes the updated PG-ID list during a subsequent process of interaction with a group user. In this manner, during the mobility of the GMC, the group nodes in the idle mode served by the GMC may not detect the changing of the PG that they belong to, thereby avoiding unnecessary location update performed by the terminals in the idle mode when moving across different PGs, and meanwhile ensuring that the terminals can be paged at any time. Therefore, the method and system disclosed in the embodiments can avoid the signaling storm raised when numbers of terminals in the idle mode initiate location update at the same time during the mobility of the GMC.

### BRIEF DESCRIPTION OF THE DRAWINGS

FIG. 1 is a schematic flow chart of an idle mode defined in IEEE 802.16e;

FIG. 2 is a schematic flow chart of message interaction in a group mobility solution in the prior art;

FIG. 3 is a schematic flow chart of a method for processing group mobility according to Embodiment 1 of the present invention;

FIG. 4 is a schematic flow chart of an air interface access of an MS defined in IEEE 802.16e;

FIG. 5 is a schematic flow chart of a GMC handover according to Embodiment 1 of the present invention;

FIG. 6 is a schematic flow chart of a process when a group node enters an idle mode according to Embodiment 1 of the present invention;

FIG. 7 is a schematic flow chart of a process when a group node withdraws from an idle mode according to Embodiment 1 of the present invention;

FIG. 8 is a schematic flow chart of a process when a group node in an idle mode performs location update according to Embodiment 1 of the present invention;

FIG. 9 is a schematic flow chart of another process when a group node in an idle mode performs location update according to Embodiment 1 of the present invention;

FIG. 10 is a schematic structural view of a wireless communication system according to Embodiment 2 of the present invention; and

FIG. 11 is a schematic structural view of a Group Mobility Controller performing according to Embodiment 3 of the present invention.

### DETAILED DESCRIPTION OF THE EMBODIMENTS

To make the objectives, technical solutions, and advantages of the present invention comprehensible, the present invention is further described in detail below through the embodiments with reference to the accompanying drawings.

### Embodiment 1

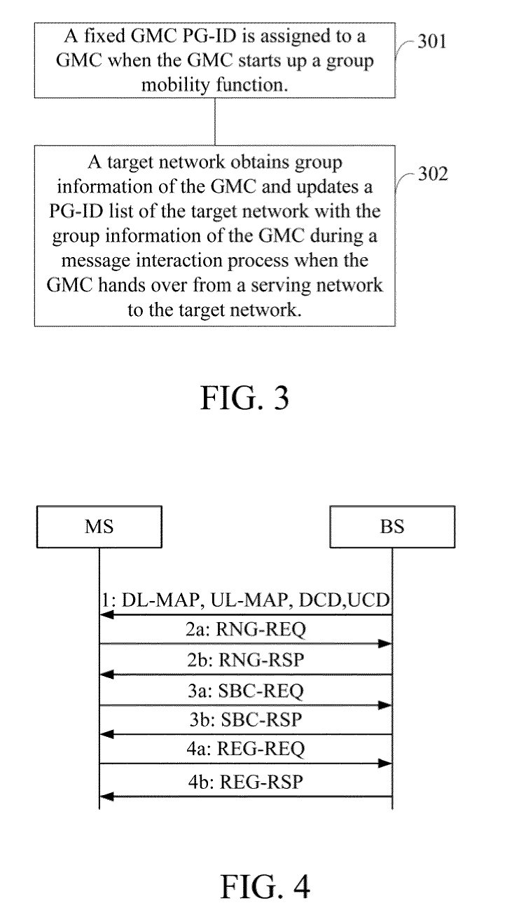

In an embodiment of the present invention, a method for processing group mobility is provided. Referring to FIG. 3, the method includes the following steps.

In Step 301, a fixed GMC PG-ID is assigned to a GMC when the GMC starts up a group mobility function.

The assigned GMC PG-ID in this embodiment remains unchanged during the whole mobility of the GMC.

In Step 302, a target network obtains group information of the GMC and updates a PG-ID list of the target network with the group information of the GMC, during a message interaction between a serving network and a target network while the GMC handing over from the serving network to the target network.

In this step, the target network obtains the group information of the GMC in the following manner: the serving network initiates a handover request to the target network according to a handover request from the GMC, and sends the group information of the GMC to the target network when the GMC determines to hand over to the target network.

Thus, during the mobility of the GMC, group nodes in the idle mode served by the GMC cannot detect the changing of the PG that they belong to, thereby avoiding the signaling storm raised when numbers of terminals in the idle mode initiate location update at the same time during the mobility of the GMC.

In Step 301, the GMC may start up the group mobility function during the GMC is registering to connect to a network or during the GMC is starting up a relay function, or after the relay function is started up. Particularly, the GMC actively reports information indicating that the GMC itself has the group mobility function to the serving network, and the serving network assigns relevant parameters required for starting up the group mobility function to the GMC according to relevant configurations of the current network, including, for example, GMC ID, GMC PG-ID, etc. Then, the following circumstances are respectively introduced.

1) The GMC starts up the group mobility function when the GMC is registering to enter the network.

The specific flow of the GMC registering to enter a network is not yet defined in the prior art. In this embodiment, the process of entering the network by the GMC may be considered substantially the same as the process of entering the network by an MS. FIG. 4 is a schematic flow chart of entering the network by the MS through an air interface defined in IEEE 802.16e. Referring to FIG. 4, the following steps are included.

In Step 1, the serving network delivers uplink and downlink parameters by using a downlink map (DL-MAP) message, or an uplink map (UL-MAP) message, or a downlink channel descriptor (DCD) message, or an uplink channel descriptor (UCD) message, etc.

In Step 2, this step further includes Step 2a and Step 2b, in which a ranging is performed, and meanwhile, power and delay parameters are adjusted through an interaction between an RNG-REQ message and an RNG-RSP message.

In Step 3, this step further includes Step 3a and Step 3b, in which versions and basic capabilities of the MS and the network are negotiated by using a subscriber station basic capability request (SBC-REQ) message and a subscriber station bask capability response (SBC-RSP) message.

In Step 4, this step includes Step 4a and Step 4b, in which, through a register request (REG-REQ) and a register response (REG-RSP), the MS is authenticated, authorized, and assigned with an IP address, and an IP connection bearer is established.

The GMC may start up the group mobility function in Step 3 or Step 4 during the above process of entering the network. By adding relevant fields for describing the group mobility information into an air interface management message, such as SBC-REQ/RSP or REG_REQ/RSP, the group mobility capability can be reported and the GMC PG-ID can be assigned.

2) The GMC starts up the group mobility function when the GMC is starting up a relay function.

When such a mode is adopted, the GMC reports its own group mobility capability while starting up the relay function, and applies to start up the group mobility function. Then, the network assigns and delivers parameters required for starting up the group mobility function to the GMC, thereby completing the start-up of the group mobility function by the GMC.

3) The GMC actively applies to start up the group mobility function after the relay function is started up by the GMC.

When such a mode is adopted, the GMC first reports its own group mobility capability during a process of capability negotiation, and then actively applies to start up the group mobility function whenever it considers necessary. Finally, the network assigns and delivers parameters required for starting up the group mobility function to the GMC, thereby completing the start-up of the group mobility function by the GMC.

4) After the relay function is started up by the GMC, the network notifies the GMC to start up the group mobility function.

When such a mode is adopted, the GMC first reports its own group mobility capability during the process of capability negotiation, and then the network assigns and delivers parameters required for starting up the group mobility function to the GMC whenever it considers necessary, and notifies the GMC to start up the group mobility function.

The processing for the group mobility in the embodiments of the present invention is described below.

As long as all the terminals served by the GMC have entered the idle mode and no uplink or downlink data is transmitted, it is possible for the GMC to enter the idle mode. Thus, in practical applications, the GMC cannot be in an idle mode, so that the mobility of the GMC is usually a handover process, rather than a location update in the idle mode.

The technical solution disclosed in this embodiment achieves an update of a PG-ID list of the target network during the handover process of the GMC, instead of the RNG process when entering a new network.

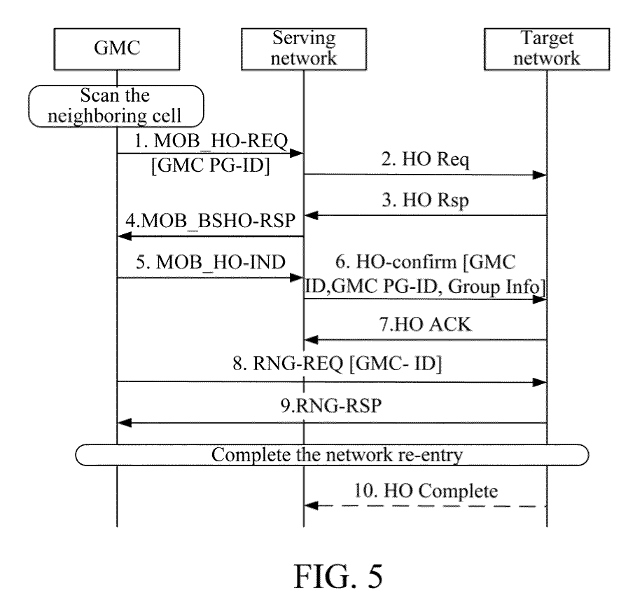

The handover process of the GMC is not yet defined detailedly in the prior art. The handover process of the GMC is shown in FIG. 5 in this embodiment. Referring to FIG. 5, the following steps are included.

In Step 1, the GMC detects signals of a target network, monitors broadcast messages, and determines to perform a handover, and then the GMC initiates a handover request to a serving network through a mobility handover request (MOB_HO-REQ) message. In this step, if the serving network does not store the GMC PG-ID of the GMC, the message needs to carry the GMC PG-ID of the GMC.

In Step 2, the serving network sends a handover request (HO Req) message to the target network, so as to query resources and request handover to the target network.

In Step 3, the target network agrees with the handover of the GMC, and returns a handover response (HO Rsp) message to the serving network.

In Step 4, the serving network notifies the GMC a handover preparation result carried in a handover response (MOB_BSHO-RSP) message.

In Step 5, the GMC initiates a handover to the selected target network, and notifies the serving network via a mobility handover indication (MOB_HO-END) message.

In Step 6, the serving network sends a handover confirm (HO-confirm) message to the target network, and notifies the target network that the GMC has started the handover process, and then the target network starts waiting for the entrance of the GMC. The HO-confirm message at least carries the GMC ID and the GMC PG-ID, and may further carry associated group information.

In Step 7, the target network returns a handover acknowledgement (HO ACK) message to the serving network to acknowledge the handover.

In Step 8, the GMC is disconnected from the original serving network, shows its own identity in the target network by carrying the GMC ID in a ranging request (RNG_REQ) message, and performs an RNG process with the target network.

In Step 9, the target network returns an RNG-RSP to the GMC, and the GMC completes re-entering the target network.

In Step 10, after the GMC has handed over to the target network, the target network sends a handover complete (HO Complete) message to the serving network to notify that the handover process is completed.

In the process shown in FIG. 5, when the target network is selected, the serving network transfers the GMC PG-ID to the target network via the HO-confirm message, and the message may further carry other group information. After receiving the message, the target network adds the GMC PG-ID into the PG-ID list of the target network itself, and then utilizes the updated PG-ID list when configuring messages carrying PG-ID parameter(s) during the subsequent process. At any time after receiving the HO-confirm message and before receiving the RNG-REQ message, the target network can perform the process of updating the PG-ID list.

In the above process, when the GMC determines to hand over to the target network, that is, the serving network receives the MOB_HO-IND message from the GMC that indicates the GMC starts a handover process, the serving network may delete the GMC PG-ID of the GMC from a PG-ID list of the serving network itself.

Alternatively, a timer is set for counting a certain time period after the serving network receives the MOB_HO-IND message, and after the timer is timeout, the serving network deletes the GMC PG-ID of the GMC from a PG-ID list of the serving network itself.

Alternatively, after receiving an HO complete notification from the target network, that is, receiving the HO-Complete message from the target network, the serving network deletes the GMC PG-ID of the GMC from a PG-ID list of the serving network itself.

Furthermore, after the target network has updated the PG-ID list of the target network, or the serving network has deleted the GMC PG-ID, the target network or the serving network may further perform an interaction process with a corresponding access service network-gateway (ASN-GW) or a paging controller (PC), so as to complete the maintenance of the PG-ID PG information and routing information.

This embodiment further provides solutions about other processes associated with the group mobility, including a process of a group node entering an idle mode, a process of the group node withdrawing from an idle mode, a process of the group node in an idle mode performing location update, a process of handling the group node that leaves the group when the group node in the idle mode leaves the group and performs location update, a process of handling a GMC when the group node in an idle mode leaves the group, and a process of the GMC stoping the group mobility function, which are respectively introduced below.

1) The process of a group node entering an idle mode:

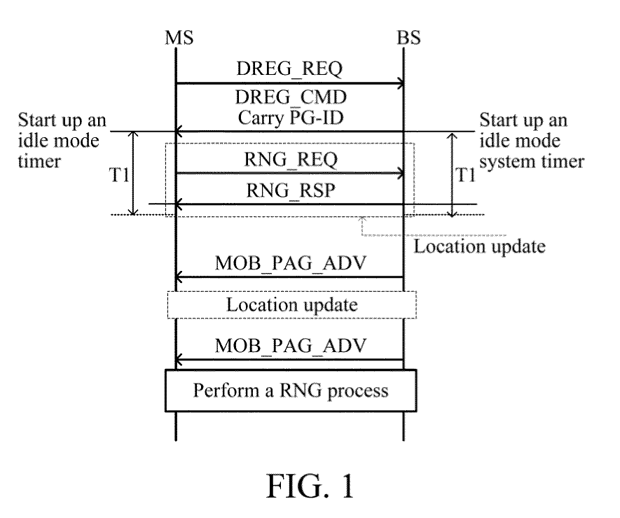

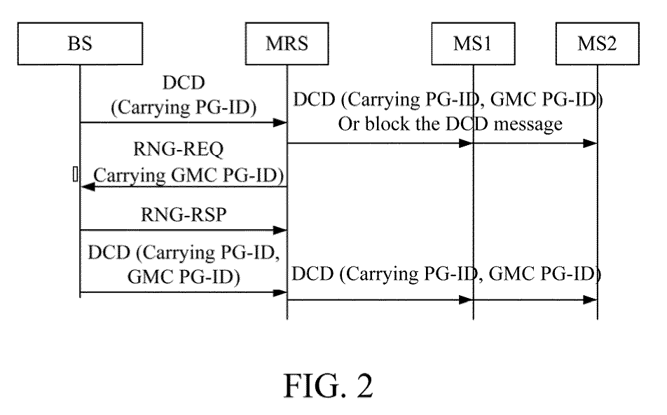

The process of a group node entering an idle mode is similar to the process when a group node enters an idle mode as shown in FIG. 1, and the difference lies in that: when a network or a GMC receives a deregister request (DREG-REQ) from an MS, finds that the MS is a group node, and delivers a deregister command (DREG-CMD) to the MS, the network or the GMC sets a PG-ID field in a paging information (Paging Info) field of the DREG-CMD as a GMC PG-ID of the GMC that the MS belongs to.

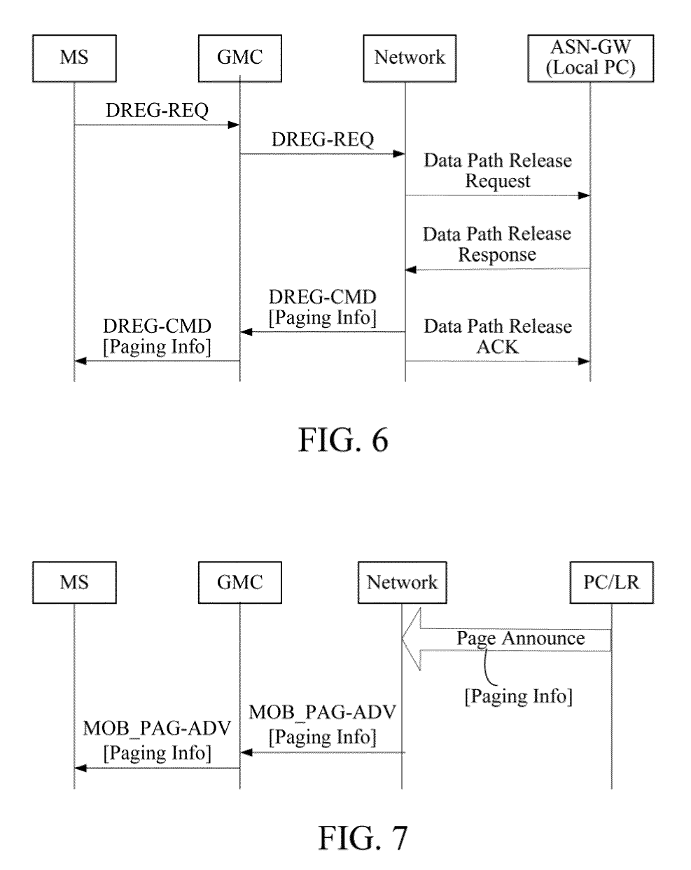

Since an integrity protection is performed on the DREG-CMD, the process when the group node enters an idle mode is further classified into two circumstances in this embodiment according to a factor that the security association is established between the MS and the network, that is, a path-based security mode, or established between the MS and the GMC, that is, a link-based security mode. FIG. 6 is a schematic flow chart of a process of a group node entering an idle mode according to Embodiment 1 of the present invention.

In the path-based security mode, the network carries the PG-ID field in the Paging Info field of the DREG-CMD message, and sets the PG-ID field as the GMC PG-ID to serve as the PG information when the MS enters an idle state. The GMC PG-ID information is the PG information reported when the GMC enters or hands over to the network.

In the link-based security mode, the network normally configures and delivers the DREG-CMD message, and the GMC modifies a relevant parameter in the DREG-CMD message, that is, carries the GMC PG-ID in the PG-ID field in the Paging Info field, which is transparent to the network.

2) The process of the group node withdrawing from an idle mode:

If the group node withdraws from an idle mode, two possible circumstances exist, that is, actively re-entering a network and making a response to the paging. The former circumstance is substantially the same as the process of re-entering a network by a terminal in an idle mode as shown in FIG. 1, and the later circumstance requires special processing by the network or the GMC. The difference between this embodiment and the process that the terminal in an idle mode withdraws from the idle mode as shown in FIG. 1 lies in that: when the network or the GMC finds that the MS is a group node and delivers the MOB_PAG-ADV message to the MS, the network or the GMC sets the PG-ID field in the Paging Info field as the GMC PG-ID of the GMC that the MS belongs to. In addition, when the network finds that the MS is a group user, the network may not broadcast the message to all the network entities within the coverage of the network, but merely send the message to the GMC of the group that the MS belongs to.

Similar to the above process of the group node entering the idle mode, the process of the group node withdrawing from an idle mode is further classified into two circumstances in this embodiment according to the factor that the security association is established between the MS and the network, or established between the MS and the GMC. FIG. 7 is a schematic flow chart of a process of a group node withdrawing from an idle mode according to Embodiment 1 of the present invention.

In the path-based security mode, the network carries the PG-ID field in the Paging Info field of the MOB_PAG-ADV message, and sets the PG-ID field as the GMC PG-ID to serve as the PG information when the MS withdraws from the idle state. The GMC PG-ID information is the PG information reported when the GMC enters or hands over to the network.

In the link-based security mode, the network normally configures and delivers the MOB_PAG-ADV message, and the GMC modifies the relevant parameter in the MOB_PAG-ADV message, that is, carries the GMC PG-ID in the PG-ID field in the Paging Info field, which is transparent to the network.

3) The process of the group node in the idle mode performing location update:

In addition to performing location update when moving across different PGs, the MS may further initiate location update in some other circumstances. For example, periodic location update based on the timer, power-off location update, or location update raised when an MAC hash skip counter (MAC HASH) for internal maintenance of an MS exceeds a threshold. In these cases, when the network finds that the MS is a group node and delivers the RNG-RSP message to the MS, the network sets the PG-ID field in the Paging Info field of the RNG-RSP message as the GMC PG-ID of the GMC that the MS belongs to.

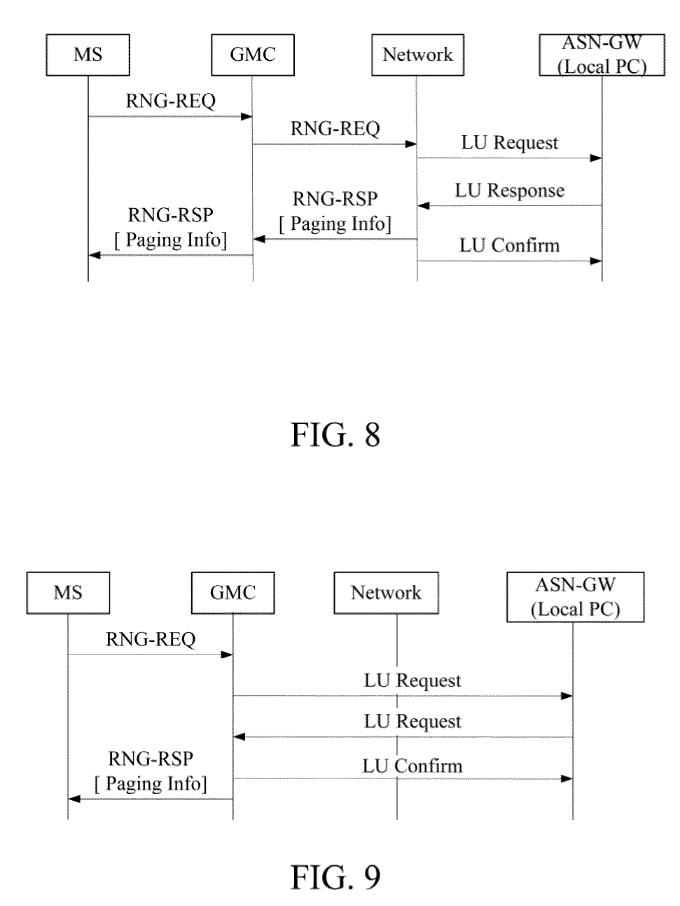

Similar to the above process when the group node enters the idle mode, the process of location update of the group node in the idle mode is further classified into two circumstances in this embodiment according to the factor that the security association is established between the MS and the network, or established between the MS and the GMC. FIG. 8 is a schematic flow chart of a process of a group node in an idle mode performing location update according to Embodiment 1 of the present invention.

In the path-based security mode, the network carries the GMC PG-ID in the PG-ID field in the Paging Info field of the RNG-RSP message to serve as the PG information when the MS performs the location update. The GMC PG-ID information is the PG information reported when the GMC accesses or hands over to the network.

In the link-based security mode, the network normally configures and delivers the RNG-RSP message, and the GMC modifies the relevant parameter in the RNG-RSP message, that is, carries the GMC PG-ID in the PG-ID field in the Paging Info field, which is transparent to the network.

If the GMC includes key information needed, the GMC may configure a location update request (LU Request) message, and send the message to the ASN-GW, which is more suitable for the circumstance of directly establishing a channel between the GMC and the ASN-GW, as shown in FIG. 9. FIG. 9 is a schematic flow chart of another process of a group node in an idle mode performing location update according to Embodiment 1 of the present invention. In the process shown in FIG. 9, the GMC configures the LU Request message, and directly sends the message to the ASN-GW.

4) The process of handling the group node that leaves the group when the group node in the idle mode leaves the group and performs location update:

When the group node in the idle mode served by the GMC leaves the coverage area of the GMC, enters a coverage area of a current serving network of the GMC, and initiates a location update to the current serving network, or when the MS that initiates the location update is not a group node, the current serving network sends the RNG-RSP message carrying the PG-ID field in the Paging Info field to the group node that leaves the group or the MS which is not a group node, and sets the PG-ID field as any value other than the GMC PG-ID, that is to say, the value of the PG-ID field cannot be the GMC PG-ID of the GMC.

In this manner, after the GMC leaves the current serving network, it can avoid the problem that numbers of MSs originally belonging to the group of the GMC initiate location update at the same time since the current serving network deletes the GMC PG-ID, and can also avoid the problem of failing to page the MSs originally belonging to the group due to the out of sequence of messages.

5) The process of handling the GMC when the group node in an idle mode leaves the group:

When the group node in the idle mode served by the GMC leaves the coverage area of the GMC, and enters a coverage area of a current serving network of the GMC, the MS may not initiate the location update before the original serving network deletes the GMC PG-ID (for example, the GMC hands over to a new serving network) since a downlink message broadcasted by the network carries the GMC PG-ID of the GMC, which may cause the inconsistence between the group information maintained on the GMC and the actual situation. This embodiment provides two modes for maintaining the information of the terminal in the idle mode in the group by the GMC.

In the first mode: the GMC periodically pages the group node in the idle mode, and when the times that the group node makes no response reach a certain threshold, the GMC deletes the group node from the group.

In the second mode: when the terminal in the idle mode leaves the group, the current serving network or PC notifies the GMC to delete the group node from the group.

6) The process of the GMC stopping the group mobility function:

The GMC may independently stop the group mobility function or may stop the group mobility function while stopping the relay function or leaving the network.

When the GMC sends information for stopping the group mobility function to the current serving network, the current serving network deletes the group information maintained by the current serving network and the assigned parameters associated with the group mobility accordingly, such as the GMC PG-ID information.

Once the GMC stops the group mobility function, the network deletes the GMC PG-ID from the PG-ID list of the network, and when the network delivers a relevant message subsequently, the Paging Info field of the message does not carry the GMC PG-ID any more.

As described above, in the method for processing group mobility according to the embodiments of the present invention, when the GMC starts up the group mobility function, the fixed GMC PG-ID is assigned for the GMC; and then the target network obtains the group information of the GMC and updates the PG-ID list of the target network with the group information of the GMC, during the message interaction process when the GMC hands over from the serving network to the target network. In this manner, during the mobility of the GMC, the group nodes in the idle mode served by the GMC cannot detect the changing of the PG, thereby preventing the terminals in the idle mode from performing unnecessary location update when moving across different PGs and meanwhile ensuring that the terminals can be paged at any time. Therefore, the method according to this embodiment of the present invention can avoid the signaling storm raised when numbers of terminals in the idle mode initiate the location update at the same time during the mobility of the GMC. In the above embodiments, the referred serving network or target network may be a BS in the WiMAX system, or Evolved NodeB (eNB) of the Long Term Evolution (LTE) of the 3GPP system.

The specific implementations of the method for processing group mobility according to the present invention have been described above in great detail, and a wireless communication system provided according to an embodiment of the present invention is introduced below with reference to the accompanying drawings.

### Embodiment 2

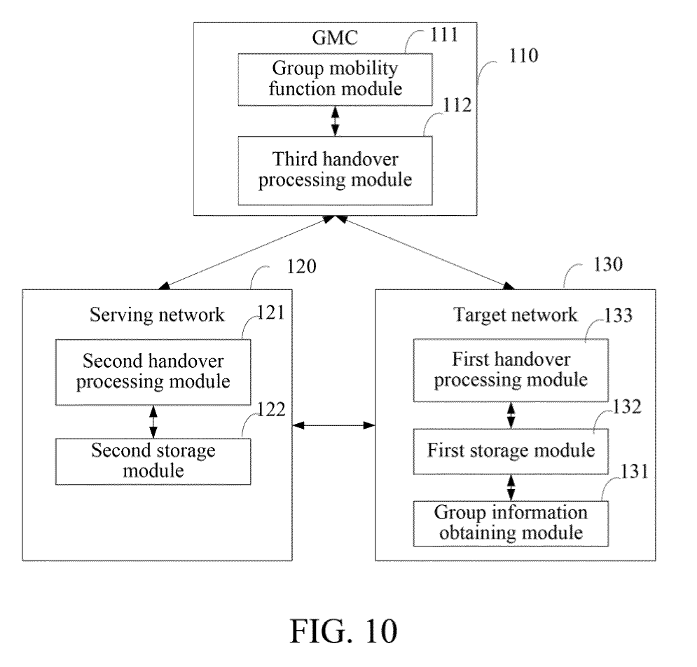

In an embodiment of the present invention, a wireless communication system is provided. Referring to FIG. 10, the system includes a GMC 110, a serving network 120, and a target network 130.

The GMC 110 further includes a group mobility function module 111. The group mobility function module 111 is adapted to start up a group mobility function, and obtain a fixed GMC PG-ID.

The target network 130 includes a group information obtaining module 131 and a first storage module 132. The group information obtaining module 131 is adapted to obtain group information of the GMC during a message interaction between the serving network 120 and the target network 130 while the GMC 110 handing over from the serving network 120 to the target network 130, and notify the first storage module 132 to update a PG-ID list stored in the first storage module 132 using the group information of the GMC.

Furthermore, the target network 130 may include a first handover processing module 133, the serving network 120 may include a second handover processing module 121 and the GMC 110 may include a third handover processing module 112.

The second handover processing module 121 is adapted to initiate a handover request to the first handover processing module 133 of the target network 130 according to a handover request from the third handover processing module 112, and send the group information of the GMC 110 to the group information obtaining module 131 of the target network 130 when receiving a notification from the third handover processing module 112 indicating that the GMC 110 determines to hand over to the target network 130.

The third handover processing module 112 is further adapted to perform an RNG process with the first handover processing module 133 through the GMC ID of the GMC so as to complete a network re-entry of the GMC in the target network 130.

The first handover processing module 133 may be further adapted to notify the second handover processing module 121 of the serving network 120 that the handover is completed after the GMC has completed the network re-entry.

Furthermore, the serving network 120 may include a second storage module 122.

The second handover processing module 121 is further adapted to notify the second storage module 122 to delete the GMC PG-ID of the GMC in the PG-ID list stored in the second storage module 122 when receiving the notification from the third handover processing module 112 indicating that the GMC 110 determines to hand over to the target network 130.

Alternatively, once receiving the notification from the third handover processing module 112 indicating that the GMC 110 determines to hand over to the target network, the second handover processing module 121 starts up a timer for counting a certain time period, and after the timer is timeout, the second handover processing module 121 notifies the second storage module 122 to delete the GMC PG-ID of the GMC 110 in the PG-ID list stored in the second storage module 122.

Alternatively, after receiving the handover complete notification from the first handover processing module 133, the second handover processing module 121 notifies the second storage module 122 to delete the GMC PG-ID of the GMC 110 in the PG-ID list stored in the second storage module 122.

Furthermore, the target network 130 of the system may also include a first notifying module, and the serving network 120 may also include a second notifying module.

After the target network 130 updates the PG-ID list, the first notifying module is adapted to notify the update to the ASN-GW or the PC of the target network 130.

After the serving network 120 deletes the GMC PG-ID from the PG-ID list, the second notifying module is adapted to notify the deletion to the ASN-GW or the PC of the serving network 120.

The GMC 110 shown in FIG. 10 may further include a first group processing module (no shown in FIG. 10), and the current serving network of the GMC 110 may further include a second group processing module (not shown in FIG. 10).

The first group processing module or the second group processing module is adapted to return a DREG-CMD carrying the PG-ID field in the Paging Info field to the group node after receiving a DREG-REQ from the group node, in which a value of the PG-ID field is set to the GMC PG-ID of the GMC.

Alternatively, the first group processing module or the second group processing module is adapted to send a MOB_PAG-ADV carrying the PG-ID field in the Paging info field to the group node, in which a value of the PG-ID field is set to the GMC PG-ID of the GMC 110.

Alternatively, the first group processing module or the second group processing module is adapted to send an RNG-RSP carrying the PG-ID field in the Paging Info field to the group node, in which a value of the PG-ID field is set to the GMC PG-ID of the GMC 110.

Furthermore, the second group processing module is adapted to notify the GMC 110 to delete the group node from the group when the group node in the idle mode served by the GMC 110 leaves the coverage area of the GMC 110 and enters the coverage area of the current serving network of the GMC 110; and is adapted to send the RNG-RSP message carrying the PG-ID field in the Paging Info field to the group node when the group node initiates location update to the current serving network, in which a value of the PG-ID field is set to a value other than the GMC PG-ID.

The first group processing module is adapted to periodically page the group node in the idle mode, and delete the group node from the group if the times that the group node makes no response reach a certain threshold.

The serving network 120 or the target network 130 referred in this embodiment are respectively a BS in the WiMAX system or an eNB in the LTE system.

As described above, through the wireless communication system provided in the embodiment of the present invention, during the mobility of the GMC, the group nodes in the idle mode served by the GMC cannot detect the changing of the PG, thereby preventing the terminals in the idle mode from performing unnecessary location update when moving across different PGs and meanwhile ensuring that the terminals can be paged at any time. Therefore, the system according to the embodiment of the present invention can avoid the signaling storm raised when numbers of terminals in the idle mode initiate the location update at the same time during the mobility of the GMC.

### Embodiment 3

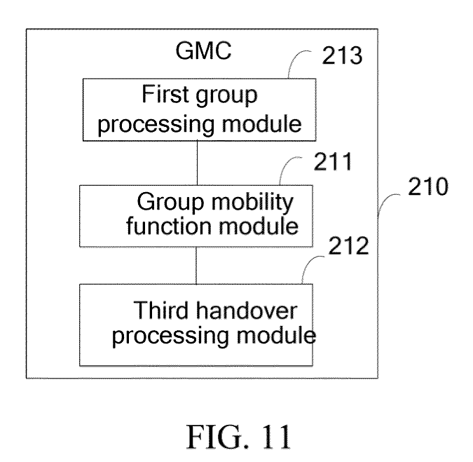

In an embodiment of the present invention, a GMC 210 is provided, which includes a group mobility function module 211 (FIG. 11).

The group mobility function module 211 is adapted to start up a group mobility function, and obtain a fixed GMC PG-ID.

The GMC 210 further includes a third handover processing module 212.

The third handover processing module 212 is adapted to send a handover request and send a notification of determining to hand over to a target network, and perform an RNG process with the target network through the GMC ID of the GMC 210 so as to complete a network re-entry of the GMC 210 in the target network.

The GMC 210 further includes a first group processing module 213.

The first group processing module 213 is adapted to return a DREG-CMD carrying a PG-ID field in a Paging Info field to a group node after receiving a DREG-REQ from the group node, in which a value of the PG-ID field is set to the GMC PG-ID of the GMC 210.

Alternatively, the first group processing module 213 is adapted to send a MOB_PAG-ADV carrying a PG-ID field in a Paging Info field to the group node, in which a value of the PG-ID field is set to the GMC PG-ID of the GMC 210.

Alternatively, the first group processing module 213 is adapted to send an RNG-RSP carrying a PG-ID field in a Paging Info field to the group node, in which a value of the PG-ID field is set to the GMC PG-ID of the GMC 210.

The first group processing module 213 is further adapted to periodically page the group node in the idle mode, and delete the group node from the group if the times that the group node makes no response reach a certain threshold.

Though the present invention has been disclosed above by the embodiments, they are not intended to limit the invention. Any modifications, equivalent substitutions, and variations made within the spirit and scope of the present invention fall within the scope of the same.

What is claimed is:

1. A method for processing group mobility, wherein a fixed group mobility controller (GMC) paging group identifier (GMC PG-ID) is assigned to a GMC when the GMC starts up a group mobility function, the method further comprising:
obtaining, by a target network, group information of the GMC; and
updating, by the target network, a PG-ID list of the target network using the group information of the GMC during a message interaction between a serving network and the target network while the GMC handing over from the serving network to the target network.

2. The method of claim 1, further comprising:
utilizing, by the target network, the updated PG-ID list during a subsequent process of interaction with a group user after the target network updates the PG-ID using the group information.

3. The method of claim 1, wherein the obtaining group information of the GMC comprises:
initiating, by the serving network, a handover request to the target network according to a handover request from the GMC; and
sending, by the serving network, the group information of the GMC to the target network when the GMC determines to hand over to the target network.

4. The method of claim 1, wherein
the GMC starts up the group mobility function during the GMC is registering to enter a network, or during the GMC is starting up a relay function, or after the relay function is started up.

5. The method of claim 1, wherein the group information at least comprises an identifier of the GMC (GMC ID) and the GMC PG-ID of the GMC; and the method further comprises:
performing a ranging (RNG) process with the target network through the GMC ID to complete a network re-entry of the GMC after the target network updates the PG-ID using the group information.

6. The method of claim 5, further comprising:
notifying, by the target network, the serving network that the GMC completed a handover after the GMC has completed the network re-entry.

7. The method of claim 1, further comprising:
deleting, by the serving network, the GMC PG-ID of the GMC from a PG-ID list of the serving network when the GMC determines to hand over to the target network; or
deleting, by the serving network, the GMC PG-ID of the GMC from the PG-ID list of the serving network after a timer is timeout, wherein the time is set by the serving network for counting a certain time period when the serving network determines to hand over to the target network.

8. The method of claim 6, further comprising:
deleting, by the serving network, the GMC PG-ID of the GMC from a PG-ID list of the serving network after the serving network receives a handover complete notification from the target network.

9. The method of claim 1, further comprising:
notifying, by the target network, an access service network-gateway (ASN-GW) or a paging controller (PC) of an update of the target network after the target network updates the PG-ID list of the target network.

10. The method of claim 7, further comprising:
notifying, by the serving network, an access service network-gateway (ASN-GW) or a paging controller (PC) of a deletion of the serving network after the serving network deletes the GMC PG-ID of the GMC from the PG-ID list of the serving network.

11. The method of claim 8, further comprising:
notifying, by the serving network, an access service network-gateway (ASN-GW) or a paging controller (PC) of a deletion of the serving network after the serving network deletes the GMC PG-ID of the GMC from the PG-ID list of the serving network.

12. The method of claim 1, further comprising:
a group node entering an idle mode;
wherein
the entering comprises:
delivering a deregister command (DREG-CMD) carrying a PG-ID field in a paging information field to the group node when the serving network receives a deregister request (DREG-REQ) from the group node; wherein
a value of the PG-ID field is set to a GMC PG-ID of the GMC that the group node belongs to.

13. The method of claim 1, further comprising:
a group node withdrawing from an idle mode;
wherein
the withdrawing comprises:
delivering a MOB_PAG-ADV message carrying a PG-ID field in a Paging Info field to the group node; wherein
a value of the PG-ID field is set to a GMC PG-ID of the GMC that the group node belongs to.

14. The method of claim 1, further comprising:
a group node in the idle mode performing location update;
wherein
the performing comprises:
delivering an RNG-RSP message carrying a PG-ID field in a Paging Info field to the group node; wherein
a value of the PG-ID field is set to a GMC PG-ID of the GMC that the group node belongs to.

15. The method of claim 1, further comprising:
handling a group node that leaves a group when the group node in an idle mode leaves the group and performs location update;
wherein
when the group node in the idle mode served by the GMC leaves the coverage area of the GMC, enters a coverage area of a current serving network of the GMC and initiates a location update to the current serving network, the handling comprises:
sending, by the current serving network, an RNG-RSP message carrying a PG-ID field in a Paging Info field to the group node; wherein
a value of the PG-ID field is set to a value other than the GMC PG-ID of the GMC.

16. The method of claim 1, further comprising:
handling the GMC when a group node in an idle mode leaves a group;
wherein
when the group node in the idle mode served by the GMC leaves the coverage area of the GMC and enters a coverage area of a current serving network of the GMC, the handling comprises:
notifying, by the current serving network, the GMC to delete the group node; or
deleting, by the GMC, the group node from the group, when the GMC periodically pages the group node in the idle mode, and the times that the group node makes no response reach a certain threshold.

17. The method of claim 1, further comprising:
deleting, by a current serving network, the group information of the GMC and the GMC PG-ID from a PG-ID list of the current serving network, when the GMC sends information for stopping the group mobility function to the current serving network.

18. A wireless telecommunication system, comprising:
a group mobility controller (GMC), a serving network and a target network;
wherein
the GMC comprises a group mobility function module, which is adapted to start up a group mobility function and obtain a fixed GMC paging group identifier (GMC PG-ID);
the target network comprises a group information obtaining module and a first storage module; wherein
the group information obtaining module is adapted to obtain group information of the GMC during a message interaction between the serving network and the target network while the GMC handing over from the serving network to the target network, and notify the first storage module to update a PG-ID list stored in the first storage module using the group information of the GMC.

19. The system of the claim 18, wherein
the target network comprises a first handover processing module; the serving network comprises a second handover processing module and the GMC comprises a third handover processing module;
wherein
the second handover processing module is adapted to initiate a handover request to the first handover processing module of the target network according to a handover request from the third handover processing module, and send the group information of the GMC to the group information obtaining module of the target network when receiving a notification from the third handover processing module indicating that the GMC determines to hand over to the target network.

20. The system of claim 19, wherein
the third handover processing module is further adapted to perform an RNG process with the first handover processing module through an identifier of the GMC (GMC ID) to complete a network re-entry of the GMC in the target network;
the first handover processing module is further adapted to notify the second handover processing module that the handover is completed after the GMC has completed the network re-entry.

21. The system of claim 20, wherein
the serving network further comprises a second storage module;
wherein
the second handover processing module is further adapted to notify the second storage module to delete the GMC PG-ID of the GMC in a PG-ID list stored in the second storage module when receiving the notification from the third handover processing module indicating that the GMC determines to hand over to the target network; or
the second handover processing module is further adapted to start up a timer for counting a certain time period when receiving a notification from the third handover processing module indicating that the GMC determines to hand over to the target network, and notify the second storage module to delete the GMC PG-ID of the GMC in the PG-ID list stored in the second storage module after the timer is time out; or
the second handover processing module is further adapted to notify the second storage module to delete the GMC PG-ID of the GMC in the PG-ID list stored in the second storage module after receiving a handover complete notification from the first handover processing module.

22. The system of claim 21, wherein
the target network further comprises a first notifying module, which is adapted to notify an access service network-gateway (ASN-GW) or a paging controller (PC) of an update of the target network when the target network updates the PG-ID list; and
the serving network further comprises a second notifying module, which is adapted to notify the ASN-GW or the PC of a deletion of the serving network after the serving network deletes the GMC PG-ID from the PG-ID list.

23. The system of claim 18, wherein the GMC further comprises a first group processing module and the current serving network of the GMC comprises a second group processing module;
wherein
the first group processing module or the second group processing module is adapted to return a DREG-CMD carrying a PG-ID field in a Paging Info field to the group node after receiving a DREG-REQ from the group node, wherein a value of the PG-ID field is set to the GMC PG-ID of the GMC; or
the first group processing module or the second group processing module is adapted to send a MOB_PAG-ADV carrying a PG-ID field in a Paging Info field to the group node, wherein a value of the PG-ID field is set to the GMC PG-ID of the GMC; or
the first group processing module or the second group processing module is adapted to send an RNG-RSP carrying a PG-ID field in a Paging Info field to the group node, wherein a value of the PG-ID field is set to the GMC PG-ID of the GMC.

24. The system of claim 23, wherein
the second group processing module is further adapted to notify the first group processing module to delete the group node from a group when the group node in the idle mode served by the GMC leaves the coverage area of the GMC and enters the coverage area of the current serving network of the GMC, and is adapted to send an RNG-RSP message carrying a PG-ID field in a Paging Info field to the group node when the group node initiates location update to the current serving network; wherein a value of the PG-ID field is set to a value other than the GMC PG-ID of the GMC.

25. The system of claim 23, wherein
the first group processing module is further adapted to periodically page the group node in the idle mode, and delete the group node from the group if the times that the group node makes no response reach a certain threshold.

26. A group mobility controller (GMC), comprising:
a group mobility function module; wherein
the group mobility function module is adapted to start up a group mobility function, and obtain a fixed GMC paging group identifier (GMC PG-ID), wherein
the GMC PG-ID is used for updating a PG-ID list of a target network during a message interaction between a serving network and the target network while the GMC handing over from the serving network to the target network.

27. The GMC of claim 26, further comprising:
a third handover processing module; wherein
the third handover processing module is adapted to send a handover request and send a notification of determining to hand over to a target network, and perform an RNG process with a target network through an identifier of the GMC (GMC ID) to complete a network re-entry of the GMC in the target network.

28. The GMC of claim 26, further comprising:
a first group processing module; wherein
the first group processing module is adapted to return a DREG-CMD carrying a PG-ID field in a Paging Info field to a group node after receiving a DREG-REQ from the group node, wherein a value of the PG-ID field is set to-the GMC PG-ID of the GMC; or
the first group processing module is adapted to send a MOB_PAG-ADV carrying a PG-ID field in a Paging Info field to the group node, wherein a value of the PG-ID field is set to the GMC PG-ID of the GMC; or
the first group processing module is adapted to send an RNG-RSP carrying a PG-ID field in a Paging Info field to the group node, wherein a value of the PG-ID field is set to the GMC PG-ID of the GMC.

29. The GMC of claim 28, wherein
the first group processing module is further adapted to periodically page the group node in the idle mode, and delete the group node from the group if the times that the group node makes no response reach a certain threshold.
